(19) United States
(12) Patent Application Publication
(10) Pub. No.: US 2016/0315927 A1
(43) Pub. Date: Oct. 27, 2016

(54) METHOD AND SYSTEM FOR ESTABLISHING AND MANAGING PERSONAL BLACK BOX (PBB) IN VIRTUALLY-NETWORKED BIG-DATA (VNBD) ENVIRONMENT

(71) Applicant: ZTE (USA) INC., Richardson, TX (US)

(72) Inventor: Bhumip Khasnabish, Lexington, MA (US)

(21) Appl. No.: 14/692,286

(22) Filed: Apr. 21, 2015

(51) Int. Cl. H04L 29/06

(52) U.S. Cl. CPC H04L 63/08

(57) ABSTRACT

A Personal Black Box (PBB) of data (and information) in a network (e.g., the Internet) is established and managed. The PBB can utilize both Personally Identifiable Information (PII) and other associated information from the public Clouds/Data-Centers to create a Personal Data Store (PDS). The PDS may contain any or all of public, private, and secret data. Authenticated access to the private data blocks may be allowed. The secret data blocks are not accessible except by the legitimate owner(s) of the data. The PBB allows partitioning of the data based on many factors including sensitivity and ownership. It is also possible to spoof potential hackers by actively inviting them into a game of sharing data, tools and techniques.

### FIELD OF THE INVENTION

This patent application relates to a method/system for establishing and managing a Personal Black Box (PBB) of personal data and information in a network, e.g., the Internet.

### BACKGROUND

Traditional methods and mechanisms for establishing a repository of personally identifiable information (PII) preserve encrypted personal information in centralized highly-reliable (geo-redundant) servers and databases. Recent advances in computing and networking technologies allow the use of a public Cloud for storing the PII. Cloud storage uses virtualized servers and Web-based technologies in order to reduce the cost of maintaining networked data storage without impeding the scaling capability of the system. For more information, please see SNIA (Storage Networking Industry Association) publication “Managing Data Storage in the Public Cloud,” (http://www.snia.org/sites/default/files/ManagingDataPublicCloud.pdf), October 2009, which is incorporated herein by reference in its entirety.

The physical database device may need to be placed in a secure area, and the contents (the PII) are protected by using multiple keys, signatures (biometric and others), and other methods and mechanisms. This method may neither be scalable nor capable of offering universal access, that is to say, access from anywhere at any time to anyone who has been authorized to access the PII.

The current trend is to utilize networked servers for collecting and harvesting PII from public, private, and semi-private sources, and then categorize the information into private, public, and sensitive (Secret, Top Secret, etc.) data blocks. Since, these categories of information are stored in a physically distributed but logically centralized server (or database), it becomes feasible to (a) dynamically update the PII, and (b) offer authorized access to the PII over e.g., the Internet after proper authentication.

The PII can be collected from public, private, and semi-private sources (sensors, web sites, etc.) and can be organized for different purposes. For example, a PBB can collect information from a set of smart body sensor objects (SBSOs), such as those described in B. Khasnabish, “Smart Body Sensor Object Networking” ZTE Communications Magazine, pp. 38-46, Issue 3 (September), 2014, which is incorporated herein by reference in its entirety. These objects can dynamically create a network for seamless communication to the PDS. This type of PDS architecture supports both flexibility and agility for services, scaling, and resiliency.

Even the SBSOs worn by a single person may generate information with different levels of privacy, from recordings of what is in plain public view to medical information about the wearer. SBSO data therefore both provides an example of and demonstrates the need for, improved handling of data in the possession of an individual.

### SUMMARY OF THE INVENTION

In one aspect, there is provided a method and apparatus for establishing and managing a Personal Black Box (PBB) of personal data and information in a network, e.g., the Internet.

In one aspect, a method of protecting stored data comprises receiving from an entity a request for access to the stored data, requesting at least one credential from the entity, when the at least one credential is determined to be correct for an entity authorized to access the data, permitting the entity to access the data, and when the at least one credential is determined not to be correct, requesting at least one additional credential from the entity.

The at least one additional credential may be instead of at least one credential previously requested, or in addition to the at least one credential previously requested. For example, when requesting the at least one additional credential from the entity, the entity may be invited to correct the at least one credential previously provided.

The entity may be invited to make at least one more attempt to authenticate itself or himself, and requested to provide at least one new credential at each iteration. The entity may also be invited to correct the at least one credential previously presented at each iteration.

When the entity has presented incorrect credentials a predetermined number of times, at least one countermeasure may be taken against the entity.

The at least one countermeasure may comprise tracing a source of the request for access.

The proposed methods and systems are different from traditional mechanisms for establishing a repository of PII, where encrypted personal information is preserved in (a) centralized highly-reliable (geo-redundant) server and database or (b) public cloud storage as described in the previous section. This type of repository can be utilized for storing and exchanging information—for example, accessing patient information by doctors in hospitals in different countries in two different continents—through a centralized key management and brokering server.

The proposed method allows partitioning of PBB information and data into different (private, public, secret, top-secret, etc.) modules, as discussed below. This partitioning offers the desired flexibility in both growth management (agility of scaling) and allowing authenticated access only to the desired band or modules of information. Every multi-factor authenticated access to the data/information module is logged (along with location, and service access data) and stored in multiple geographically distributed physical servers in order to facilitate audits and verification, as required by the evolving regulations of using Virtualized Data Center Services (VDCS). For more details, please see IETF draft “Security Framework for Virtualized Data Center Services,” December 2012, available at http://tools.ietf.org/id/draft-karavettil-vdcs-security-framework-05.txt), which is incorporated herein by reference in its entirety.

In addition, the networked PDS based PBB supports seamless scaling, mobility, protection, and portability of the service and information.

The PBB can utilize both Personally Identifiable Information (PII) and other associated information from the public Clouds and/or Data-Centers to create a Personal Data Store (PDS). For a definition of PII, please see NIST Spcl. Pub. 800-122, “Guide to Protecting the Confidentiality of Personally Identifiable Information (PII), (http://604 rcsrc.nist.gov/publications/nistpubs/800-122/sp800-122.pdf), April 2010, For a more detailed discussion of the use of public clouds in this context, please see B. Khasnabish, “Mobile Cloud for Personalized Any-Media Services” ZTE Communications, pp. 47-54, No. 3, September 2012. For further information on PDS, please see, for example, the description of the MIT OpenPDS project at http://openpds.media.mit.edu/, Accessed in February 2015. All of those references are incorporated herein by reference in their entirety.

The PDS may contain data of one or more different levels of access control, such as one or more of public, private, and secret data. Authenticated access to the private data blocks may be allowed.

In an embodiment, the secret data blocks are neither accessible nor hack-able except by the legitimate owner(s) of the data. Note that the ‘secret data blocks’ can be further partitioned into two or more blocks like “Top Secret” and “Secret.”

The proposed method is novel in the sense that it allows partitioning of the data based on sensitivity, ownership, and many other factors. This method can also spoof the potential hackers by actively inviting them into a game of sharing data, tools and techniques.

If desired, the PDS can chase the hackers and unauthorized entrants by activating scripts/agents that will frequently invite the hackers with an objective to cause irreversible damage and ultimately destroy it.

In other aspects, the invention provides a system and a computer program having features and advantages corresponding to those discussed above.

### BRIEF DESCRIPTION OF THE DRAWINGS

Having thus described the invention in general terms, reference will now be made to the accompanying drawings, Which are not necessarily drawn to scale, and wherein:

FIG. 1 shows virtualized entities in a Body Sensor Network Object (BSNO).

FIG. 2 presents an architecture for a Personal Data Store (PDS).

FIG. 3 describes a high-level architecture of a network that uses BSNOs.

FIG. 4 depicts an architecture for clustering and virtual-ring based communication among the (Smart) Body Sensor Objects (S/BSOs).

FIG. 5 shows a sequence of steps for collecting and processing monitored data/information from body sensors.

FIG. 6 illustrates a sequence of steps to hinder unauthorized access to the information in the PDS.

### DETAILED DESCRIPTION OF THE INVENTION

Embodiments of the present methods and apparatus will be described more fully hereinafter with reference to the accompanying drawings.

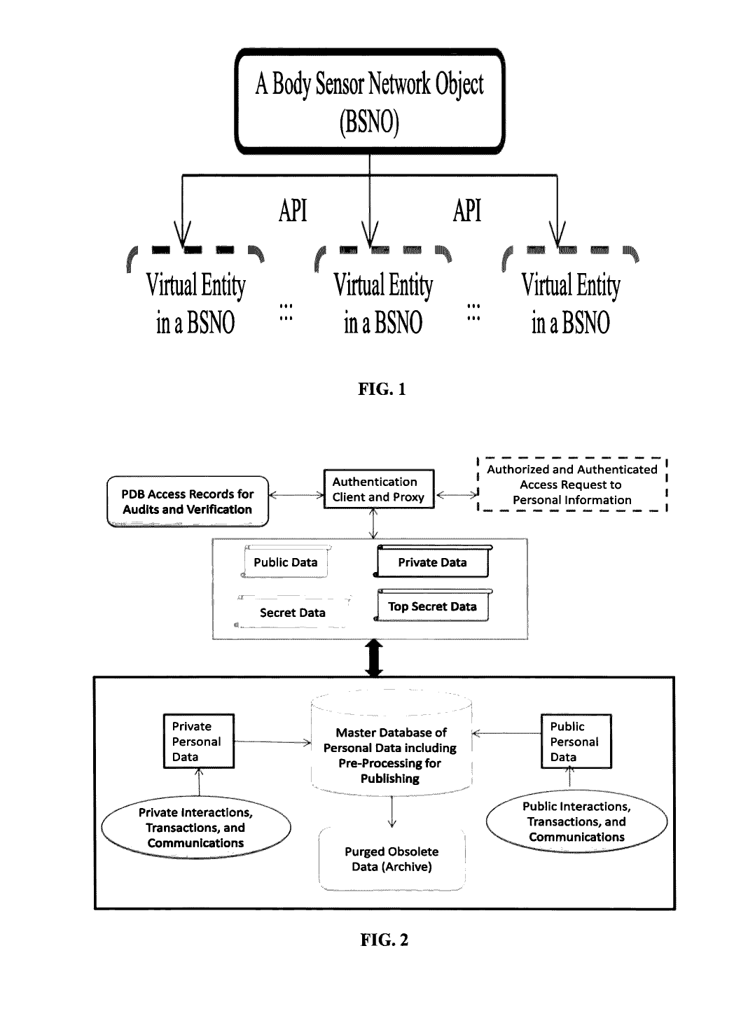

FIG. 1 shows virtualized entities in a body sensor network object (BSNO). Note that smartness can be embedded in different modules of BSNO. The BSNO can be a source of data to be stored in a Personal Data Store (PDS).

FIG. 2 presents an embodiment of an architecture for a PDS. The PDS collects, categorizes, stores, and offers Application Programming Interfaces (APIs) for appropriate access. The collection can be from both private and public interactions of a person with applications and services (email, web access and browsing, etc.), and with systems (census, blogs, etc.). The maintenance, including archiving and categorization, can be based on different criteria. Although further granularization is possible, personal data can be categorized into private, public, secret and top-secret as shown in FIG. 2. The access to the PDS can be for PBB (Personal Black Box) and other applications, and different APIs can be utilized after appropriate (embedded or on-demand) authentication service.

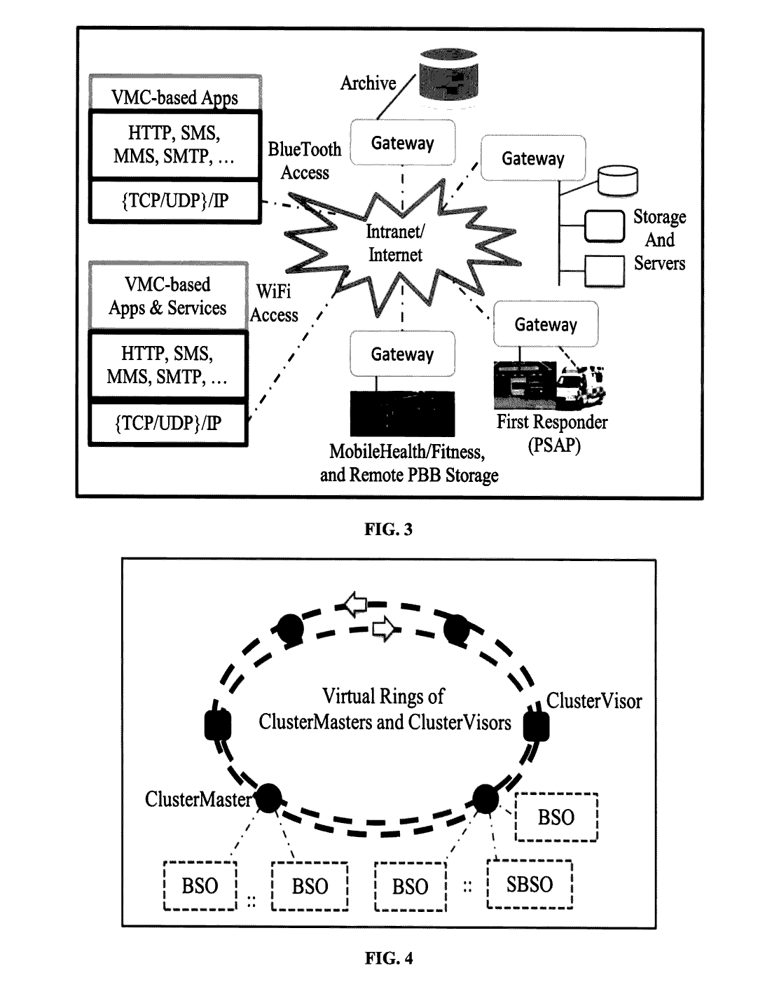

FIG. 3 illustrates a high-level architecture of a network that uses BSNOs. Open server side and open client side APIs are used, and no specialized APIs are needed. Embedded web services using light-weight versions of protocols like HTTP, XML, JSON, and Constrained Application Protocol (CoAP) are utilized depending on the foot-print, power budget, and capability requirements. Vital Monitoring Cluster (VMC) based applications and services that run seamlessly and with low-memory and processing overhead are utilized for the purpose of smart body sensor object networking. For more detail on CoAP, please see The Constrained Application Protocol (CoAP), IETF RFC 7252, June 2014, available at http://www.rfc-editor.org/rfc/rfc7252.txt, which is incorporated herein by reference in its entirety.

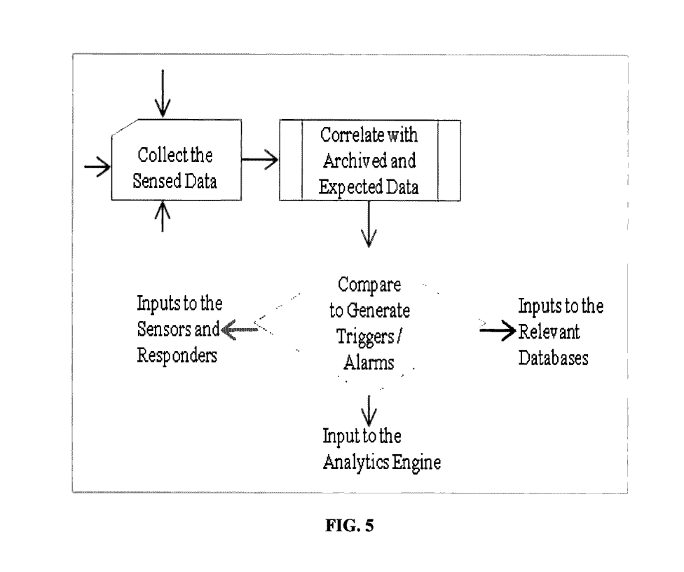

FIG. 4 depicts an architecture for clustering and virtual-ring based communication among Body Sensor Objects (BSOs), which may include Smart Body Sensor Objects (SBSOs). BSOs may use active Radio-frequency identification (RFID) tags for identification and communication. However, each BSO may in addition need another identifier for privacy and security reasons. Based on a pre-specified and pre-programmed interface, each BSO continuously or periodically logs sensed data in, for example, comma-separated value (CSV) format. A BSO may also receive input data from secondary and tertiary BSOs that may be members of the same BSO cluster group, via a ClusterMaster or ClusterVisor, as shown in FIG. 4). The stored log data are processed in real-time to locate anomalies—threshold crossing and correlated events—and then uploaded to archive or to replenish the stored information. For example, a refined version of Message Queuing Telemetry Transport (MQTT) can be effectively utilized for automated local and remote status updating and trigger generation. Where the BSOs are monitoring the physiological status of the wearer's body, for example, a trigger in response to an anomaly may send out an alarm, a call to a First-Responder, etc.). For more detail on MQTT, please see “Message Queuing Telemetry Transport (MQTT) for lightweight publish/subscribe messaging transport, 2014, available at http://mqtt.org/.

FIG. 5 shows a sequence of steps for collecting and processing the monitored data/information from the body sensors. Additional modules and analyses can be easily utilized for anomaly detection and clustering-based discovery of abnormality in the monitored information streams.

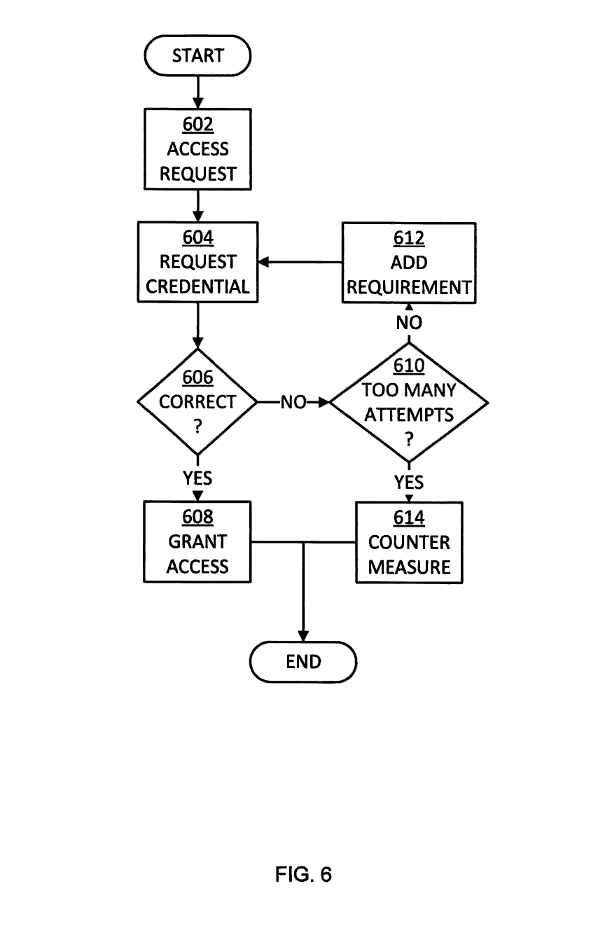

FIG. 6 illustrates a sequence of steps to hinder unauthorized access to the information in the PDS.

In step 602, the Authentication Client and Proxy (see FIG. 2) receives from an entity a request for access to the stored data, or some of the stored data. In an embodiment, the request is received over the internet or other public network, and the Authentication Client initially does not know who or what the entity is.

In step 604, the Authentication Client requests at least one credential from the entity. For example, the Authentication Client may present a login screen requiring a username and password. In that case, the initial request may be implied by the entity accessing the login screen.

In step 606, the Authentication Client determines whether the at least one credential is determined to be correct for an entity authorized to access the data.

If the at least one credential is correct, in step 608 the Authentication Client permits the entity to access the data. As is known, the Authentication Client may accept more than one different at least one credential, and may grant access to different parts of the data in the PDS depending on the credential(s) accepted. For example, Secret data may be accessible only to the owner of the data, while Private data may be accessible to additional entities previously approved by the owner, or to classes of entity recognized as entitled to access that class of data.

If at step 606 the at least one credential is not correct, in step 610 the Authentication Client determines Whether a permitted number of trials has been exceeded.

If the permitted number of trials has not been exceeded, in step 612 the Authentication Client adds a new credential to the request, and returns to step 604. The new credential may be instead of or in addition to, the at least one credential previously requested. For example, if at the first attempt the login screen required only a username and password, at the second attempt the login screen may require a username, password, and some additional personal information or the previously agreed answer to a security question. This is in contrast to conventional login systems, where the login screen typically allows repeated attempts to present the same credentials, and answers to additional security questions are requested only if the entity trying to log in admits that he, she, or it is unable to provide the credentials originally requested.

Inviting the entity to present again (and by implication to correct) the original username and password, as well as answering the additional question, gives the appearance that the Authentication Client assumes the previous invalid credentials were an innocent error by a bona-fide user. If the Authentication Client in fact suspects that the entity is a hacker, that appearance can be useful in lulling the hacker into a false sense that he or it has not been detected.

The process may loop through steps 604, 606, 610, 612 several times, requiring a more difficult set of credentials each time.

If at step 610 the permitted number of trials has been exceeded, the process branches to step 614, assumes that the entity seeking access is a hacker or other unauthorized entity, and takes active countermeasures. For example, the Authentication Client may take active steps to trace from Where the access request is originating. Hackers often attempt to obscure their identity by sending their access requests from, or routing their access requests through, different source computers, but the hacker's choice of computer or computers can still be informative.

It is probably impossible to make any normal computer system truly hackproof, except by totally isolating the system. However, it is possible to make a system unhackable at the level that the cost (in time, work, and commitment of resources that could have been used for some other purpose) required to hack the system exceeds the value of the data obtained by hacking it. That is particularly true of the private data of ordinary people for the purposes of identity theft, where the value of the personal data is effectively determined by the cost of obtaining the most vulnerable personal data, so that the ordinary hacker can be effectively deterred by making the PDS only moderately more secure than average.

1. A method of protecting stored data, comprising:
receiving from an entity a request for access to the stored data;
requesting at least one credential from the entity;
when the at least one credential is determined to be correct for an entity authorized to access the data, permitting the entity to access the data;
when the at least one credential is determined not to be correct, requesting at least one additional credential from the entity.

2. The method of claim 1, further comprising, when requesting at least one additional credential from the entity, inviting the entity to correct the at least one credential previously provided.

3. The method of claim 1, inviting the entity to correct the at least one credential at least once more, and requesting at least one additional credential from the entity at each iteration.

4. The method of claim 1 further comprising, when the entity has presented incorrect credentials a predetermined number of times, taking at least one countermeasure against the entity.

5. The method of claim 4, wherein the at least one countermeasure comprises tracing a source of the request for access.
